(19) United States
(12) Patent Application Publication
(10) Pub. No.: US 2014/0223701 A1
(43) Pub. Date: Aug. 14, 2014

(54) ATTACHMENT DEVICES

(71) Applicant: Boston Scientific Scimed, Inc., Maple Grove, MN (US)

(72) Inventors: Jeffrey BEAN, Fitchburg, MA (US); Maria MAILLET, Hudson, MA (US); Brad ISAACSON, Lancaster, MA (US); Caroline RIEDEL, Weston, MA (US); Gary KAPPEL, Acton, MA (US); John GOLDEN, Norton, MA (US); Christopher BENNING, Lowell, MA (US)

(73) Assignee: Boston Scientific Scimed, Inc., Maple Grove, MN (US)

(21) Appl. No.: 14/177,802

(22) Filed: Feb. 11, 2014

Related U.S. Application Data
(60) Provisional application No. 61/763,228, filed on Feb. 11, 2013.

(51) Int. Cl. F16B 2/10; F16B 2/06

(52) U.S. Cl. CPC F16B 2/10; F16B 2/06
USPC 24/483; 24/455

(57) ABSTRACT

Various attachment devices are disclosed. The devices are designed to permit a second medical device to be easily and quickly attached to and detached from a first medical device. The attachment devices, once attached to both the first medical device and the second medical device, may allow the physician to grasp only a single device while the other device remains securely attached to the one being grasped.

### CROSS-REFERENCE TO RELATED APPLICATIONS

This application claims the benefit of priority from U.S. Provisional Application No. 61/763,228, filed on Feb. 11, 2013, the entirety of which is incorporated by reference herein.

### FIELD OF THE DISCLOSURE

Embodiments of the present disclosure relate generally to medical devices. More particularly, embodiments of the present disclosure relate to various attachment devices for securing a second medical device to a first medical device.

### BACKGROUND

Two or more medical devices may be used together during the same medical procedure. For example, in the performance of minimally-invasive types of procedures using an endoscope, a second medical device is sometimes inserted through the working channel of the endoscope. Either the endoscope or the second medical device can provide illumination and imaging capabilities while the other may perform a distinct or specialized function. Having to hold two devices may be burdensome for the physician. There is therefore a need to provide an attachment device that may allow a physician to grasp only a single medical device during a procedure while the other medical device remains securely attached to the one being grasped.

### SUMMARY OF THE DISCLOSURE

Various attachment devices are disclosed. The attachment devices are designed to be easily and quickly attached to and detached from a first medical device. In some embodiments, the attachment devices may facilitate a second medical device to be attached to and detached from the first medical device. The attachment devices, once attached to both the first medical device and the second medical device, may allow the physician to grasp only a single medical device while the other medical device remains securely attached to the one being grasped.

One embodiment of the disclosure is directed to a device for securing a second medical device to a first medical device. The device may include a first portion configured to securely fit onto the first medical device and a port portion adjacent to the first portion. The port portion may be configured to align with a port of the first medical device and orient the first medical device relative to the second medical device so that an elongate member of the second medical device can be inserted into the port. The device may further include a second portion configured to be coupled to the second medical device so as to hinder movement of the second medical device relative to the first medical device.

In various embodiments, the device may include one or more of the following additional features: wherein the first portion includes a pair of jaws configured to deflect to receive the first medical device and return to substantially an original configuration to securely retain the first medical device, wherein the port portion is an opening defined by the first portion; wherein the first portion has a first longitudinal axis, the port portion has a second longitudinal axis angled relative to the first longitudinal axis, and wherein the port portion is configured to securely fit onto the port; wherein the port portion includes a port receiving portion and a port seating portion, wherein the port seating portion is configured to receive a proximalmost end of the port; wherein the port portion has a first end and a second end, wherein the first portion extends from the first end in a first direction and the second portion extends from the second end in a second direction that is different than the first direction; and further including a flexible strap extending from the second portion and configured to secure the second portion to the first medical device.

Another embodiment of the disclosure is directed to a device for securing a second medical device to a first medical device. The device may include a clamping portion configured to clamp onto the first medical device and an adjusting member configured to move relative to the clamping portion. The adjusting member may be configured to restrict the clamping portion from moving relative to the first medical device. The device may further include a mounting portion configured to be coupled to the second medical device so as to securely seat an elongate member of the second medical device in a port of the first medical device.

In various embodiments, the device may include one or more of the following additional features: wherein the clamping portion has a C-shaped configuration and defines a first end and a second end; wherein the adjusting portion includes a fitting and a fitting receiving member, wherein the fitting is disposed on the first end of the clamping portion, and the fitting receiving member is disposed on the second end of the clamping portion; wherein the fitting includes a knob and a plurality of threads on an end of the fitting opposite the knob, and wherein, on rotation of the knob, the fitting is configured to be threaded into a bore of the fitting receiving member; wherein the mounting portion includes at least one recess having an aperture configured to receive a securing device on the second medical device; wherein the clamp portion includes: a base having a first surface, a second surface, and a bore extending through the first surface and the second surface; and wherein the clamping portion extends from the second surface; wherein the adjusting member is threaded in the bore, wherein the mounting portion is disposed on a first end of the adjusting member and fixed to the second medical device, and wherein a clamping plate is disposed on a second end of the adjusting member; wherein, when the second medical device is rotated from a first position, in which a longitudinal axis of the second medical device is substantially perpendicular to a longitudinal axis of the first medical device, to a second position, the clamping plate is moved from a first position within the bore to a second position contacting the first medical device; wherein the longitudinal axis of the second medical device is substantially aligned with the longitudinal axis of the first medical device when the clamping plate is in the second position; and wherein the clamping plate applies a clamping force to an outer surface of the first medical device in the second position to lock the second medical device to the first medical device.

Yet another embodiment of the disclosure is directed to a device for securing a second medical device to a first medical device. The device may include a first portion configured to securely fit onto a handle of the first medical device, the first portion having a pair of jaws configured to deflect to receive the handle and return to substantially an original configuration to securely retain the handle. The device may further include a second portion configured to be coupled to the second medical device so as to hinder movement of the second medical device relative to the first medical device. The second portion may be configured to receive and retain a mounting component coupled to the second medical device.

In various embodiments, the device may include one or more of the following additional features: at least one protrusion disposed on an inner surface of the jaws, the protrusion being configured to deflect when the first medical device is inserted between the pair of jaws; and wherein each jaw of the pair of jaws includes at least one slot to form flanges of the jaw that can flex relative to one another.

Additional objects and advantages of the disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles of the disclosure.

### BRIEF DESCRIPTION OF THE DRAWINGS

FIG. 1 is a perspective view of a medical system having a second medical device secured to a first medical device via an attachment device, according to an embodiment of the present disclosure;

FIG. 2A is a partial perspective view of the second medical device of FIG.

FIG. 2B is a partial perspective view of the first medical device of FIG. 1 with the attachment device attached to the first medical device.

FIG. 3A is a perspective view of an attachment device according to another embodiment of the present disclosure.

FIG. 3B is perspective view of an alternative embodiment of the attachment device of FIG. 3A.

FIG. 3C is a perspective view of another alternative embodiment of the attachment device of FIG. 3A attached to a first medical device.

FIG. 3D is a perspective view of another alternative embodiment of the attachment device of FIG. 3A.

FIG. 4A is a perspective view of an attachment device according to another embodiment of the present disclosure.

FIG. 4B is a perspective view of an alternative embodiment of the attachment device of FIG. 4A.

FIG. 5 is a perspective view of an attachment device according to another embodiment of the present disclosure.

FIG. 6A is a partial perspective view of a first medical device having a second medical device secured to the first medical device via an attachment device according to another embodiment of the present disclosure.

FIG. 6B is a top view of a first attachment portion of the attachment device of FIG. 6A.

FIG. 6C is a perspective view of the attachment device of FIG. 6A with the second medical device secured to the attachment device.

FIG. 6D is a schematic illustration of the attachment device of FIGS. 6A and 6C.

FIG. 7A is a partial perspective view of a first medical device having a second medical device placed on the first medical device via an attachment device according to another embodiment of the present disclosure, a proximal end of the second medical device is substantially perpendicular to an outer tube of the first medical device.

FIG. 7B is a partial perspective view of the first medical device of FIG. 7A with the second medical device secured to and aligned with the first medical device.

FIG. 7C is a perspective view of the attachment device of FIGS. 7A and 7B.

FIG. 7D is a cross-sectional view of the attachment device of FIGS. 7A and 7C with a clamping plate in a first position.

FIG. 7E is a cross-sectional view of the attachment device of FIGS. 7A and 7B with the clamping plate in a second position.

FIG. 8A is a partial side view of a first medical device having a second medical device placed on the first medical device via an attachment device according to another embodiment of the present disclosure, with a longitudinal axis of a handle of the second medical device angled relative to the outer tube of the first medical device.

FIG. 8B is a partial side view of the first medical device of FIG. 8A with the second medical device secured to and aligned with the first medical device.

FIG. 8C is a partial perspective view of the first medical device of FIG. 8A with the second medical device secured to and aligned with the first medical device.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

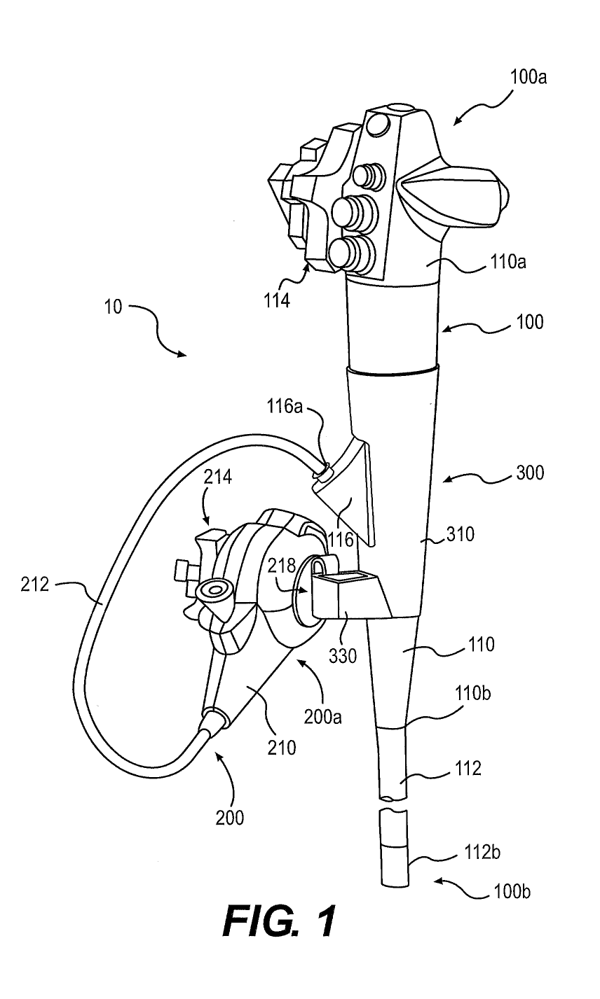

FIG. 1 illustrates an exemplary medical system 10 and related components. The exemplary medical system may be used for therapeutic and/or diagnostic endoscopic procedures. For purposes of this disclosure, the phrase “endoscopic procedure” is broadly used to indicate any medical procedure that may be performed by inserting an endoscope, ureteroscope, bronchoscope, colonoscope, laparoscope, guide tube, catheter, or any like medical device into the body through any natural, surgical, percutaneous, or other opening in the body. The term “medical system” is also used broadly to include all components and systems that may be used for the endoscopic procedure. In the exemplary embodiment, the components of medical system 10 include a first medical device 100 and a second medical device 200. First medical device 100 and second medical device 200 may be an endoscope and an endoscopic device, respectively. In other embodiments, first medical device 100 may be a ureteroscope, colonoscope, laparoscope, guide tube, catheter, or any like medical device. Additionally and/or alternatively, second medical device 200 may be a visualization device, a catheter, an instrument, an imaging device, or any other like medical device. As will be discussed in more detail below, second medical device 200 may be secured to first medical device 100 via an attachment device 300.

First medical device 100 includes a proximal end 100a and a distal end 100b, and an outer tube 112 extending between proximal end 100a and distal end 100b. For purposes of this disclosure, “proximal” refers to the end closer to the device operator during use, and “distal” refers to the end further from the device operator during use.

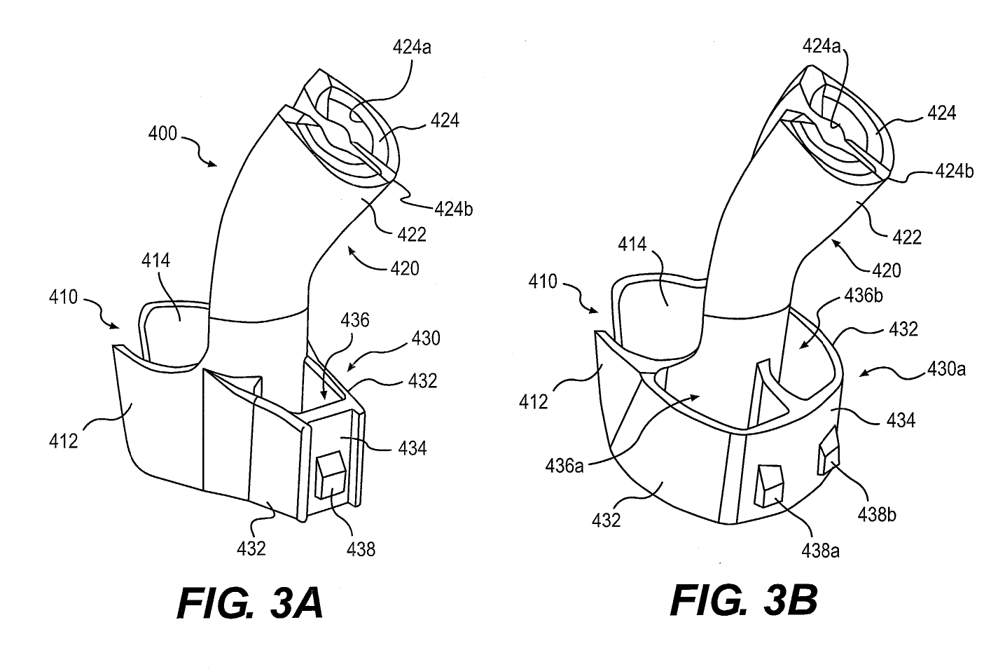

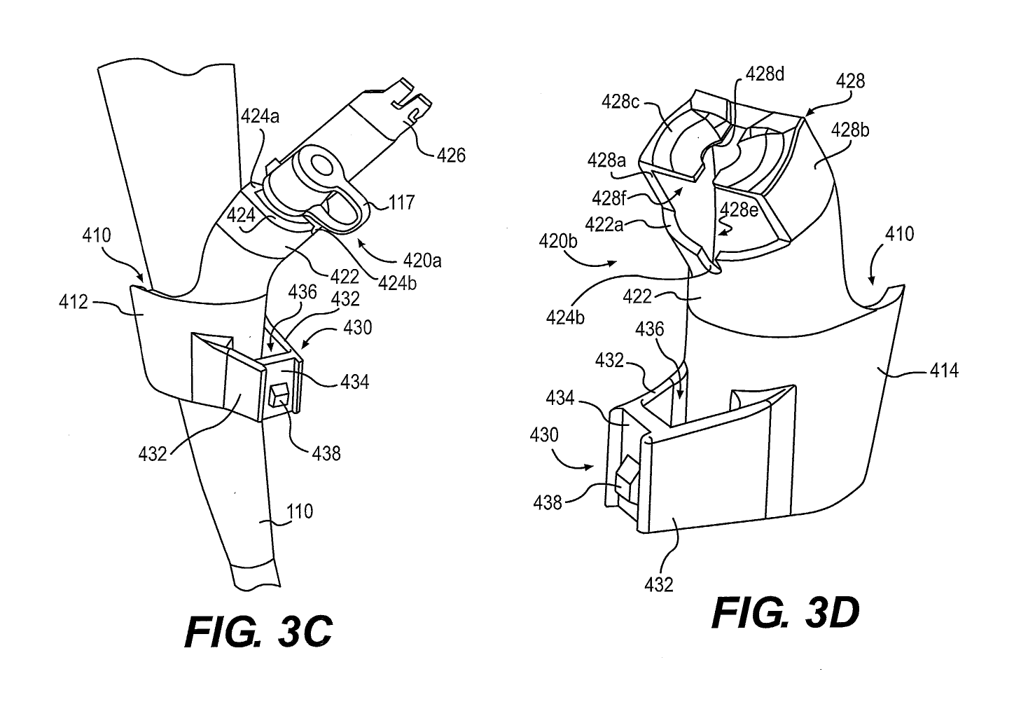

A handle 110 is disposed at proximal end 100a of first medical device 100. Handle 110 may be any known, suitable handle. As illustrated in FIG. 1, handle 110 includes a proximal end 110a and distal end 110b. A steering mechanism 114 is disposed at proximal end 110a of handle 110. Steering mechanism 114 may be connected to control wires or cables (not shown) within outer tube 112, to provide up/down and left/right steering of distal end 100b of first medical device 100. A port 116 is disposed between proximal end 110a and distal end 110b of handle 110. In some embodiments, port 116 may have a longitudinal axis that is angled relative to a longitudinal axis of handle 110. Port 116 may include a proximalmost end 116a which may provide access to a working channel (not shown) of outer tube 112 from a position exterior to first medical device 100. In some embodiments, a cap 117 (FIG. 3C) may be removably or permanently attached to proximalmost end 116a to provide access to port 116.

Outer tube 112 extends distally from distal end 110b of handle 110 and terminates at a distal end 112b. Outer tube 112 may be a flexible tube, made from any suitable biocompatible material known to one of ordinary skill in the art and having sufficient flexibility to traverse tortuous anatomy. Such materials may include, but are not limited to, rubber, silicon, polymers, stainless steel, metal-polymer composites, and metal alloys of nickel, titanium, copper cobalt, vanadium, chromium, and iron. In one embodiment, the material forming outer tube 112 may be a superelastic material such as nitinol, which is a nickel-titanium alloy. Outer tube 112 may have any cross-sectional shape and/or configuration and may be any desired dimension that can be received in a body cavity. Outer tube, or any tubes, may be reinforced with braiding, coils, reinforcing fibers, etc. Throughout the disclosure it should be noted that any materials, tubular or not, may be so reinforced.

Second medical device 200 includes a proximal end 200a and a distal end (not shown), and an elongate member 212 extending between proximal end 200a and the distal end. A handle 210 is positioned at proximal end 200a of second medical device 200. Handle 210 may be any known, suitable handle having a steering mechanism 214 to facilitate operation and manipulation of elongate member 212 and/or any other actuator to operate components at the distal end of second medical device 200. Elongate member 212 may have any size, shape, cross-sectional area and/or configuration to be inserted into and advanced through the working channel of outer tube 112 to distal end 100b of first medical device 100.

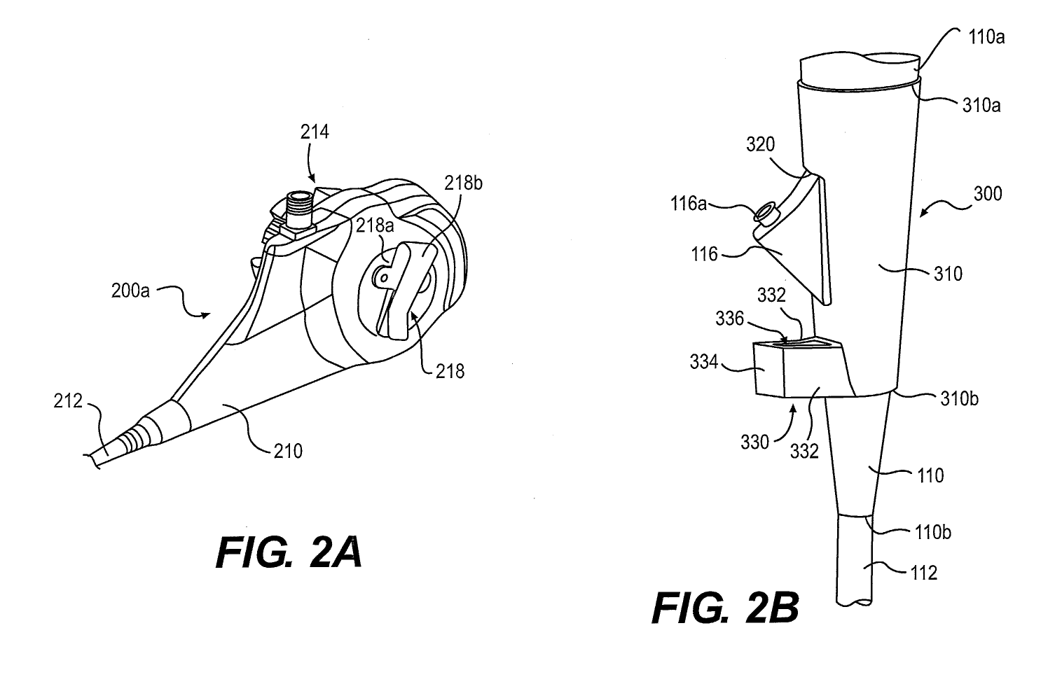

Second medical device 200 includes a securing device 218 on handle 210. Securing device 218 may be any structure known to one of ordinary skill in the art configured to be easily and quickly attached to and detached from attachment device 300. Securing device 218 may be constructed of a resilient or rigid material. Such materials may include, but are not limited to, elastomers, plastics, or metal alloys. Referring to FIG. 2A, securing device 218 may include a base 218a and at least one mounting component 218b. In some embodiments, handle 210 and base 218a may be integrally molded. In another embodiments, base 218a may be attached to handle 210 by adhesive materials or fasteners (e.g., Velcro®, screws, clips, or magnets) to secure base 218a to handle 210. The at least one mounting component 218b may be integrally formed with base 218a and extend from base 218a. The at least one mounting component 218b may be removably attached to attachment device 300. The at least one mounting component 218b may be any known mounting component including, but not limited to, clamps, clips, pegs, pins, Velcro®, threaded and non-threaded fasteners, and female engaging members having any shape, size, and/or configuration. In an exemplary embodiment illustrated in FIG. 2A, mounting component 218b is a spring clip. It will be understood, however, that mounting component 218b may be pressure clip, alligator clip, or any other type of clip known to those in the art.

Attachment device 300 may be a one-piece structure fabricated from any known process such as, for example, injection molding, and constructed of material capable of elastic displacement and/or deformation. Such materials may include, but are not limited to, plastics, polymers, and metal-polymer composites. Attachment device 300 may include a first attachment portion 310 and a second attachment portion 330. First attachment portion 310 may be configured to attach to proximal end 100a of first medical device 100, and proximal end 200a of second medical device 200 may be configured to be removably attached to second attachment portion 330. When attachment device 300 is attached to proximal end 100a of first medical device 100 and proximal end 200a of second medical device, second medical device 200 may be secured to first medical device 100.

Referring to FIG. 2B, first attachment portion 310 of attachment device 300 is a hollow tube or cylinder having a diameter that tapers from a first end 310a to a second end 310b and is dimensioned to receive handle 110. It will be understood that first attachment portion 310 may have any other size, shape, and/or configuration that generally conforms to handle 110. First attachment portion 310 includes a port attachment portion 320 disposed between first end 310a and second end 310b. In the exemplary embodiment, port attachment portion 320 may be a hole or opening sized and shaped to receive port 116.

First attachment portion 310 may be configured to slide over outer tube 112 and fit securely onto handle 110. As shown in FIG. 2B, first attachment portion 310 is positioned on handle 110 between proximal end 110a and distal end 110b. In some embodiments, first attachment portion 310 may include one or more slits (not shown) extending distally from first end 310a. The slits may extend partially or entirely along the length of first attachment portion 310. The slits may facilitate the alignment of port attachment portion 320 with port 116 as first attachment portion 310 slides onto handle 110. For example, a single slit extending from first end 310a to a proximal end of port attachment portion (opening) 320 may permit positioning of port attachment portion 320 over port 116.

Second attachment portion 330 is positioned at or adjacent to second end 310b and distal to port attachment portion 320. As shown in FIG. 2B, second attachment portion 330 may extend in a direction perpendicular to a longitudinal axis of first attachment portion 310, although the angle is not restricted to perpendicular. Second attachment portion 330 includes a mounting wall 334 and a pair of side walls 332 that, together, define a cavity 336 therein. In general, proximal end 200a of second medical device 200 may be configured to be removably attached to second attachment portion 330 via securing device 218. In the exemplary embodiments illustrated in FIGS. 1-3, mounting component 218b of securing device 218 may be clipped onto one of slide walls 332 and mounting wall 334 of second attachment portion 330 to secure proximal end 200a of second medical device 200 to attachment device 300 (FIG. 1). When attachment device 300 is attached to both proximal end 100a of first medical device 100 and proximal end 200a of second medical device 200, second medical device 200 may be secured to first medical device 100. Second medical device 200 may be easily detached from first medical device 100 by removing mounting component 218b from second attachment portion 330.

FIG. 3A illustrates an attachment device 400 in accordance with another embodiment of the disclosure. Attachment device 400 may be a one-piece structure fabricated from any known process such as, for example, injection molding, and constructed of a flexible or semi-rigid material. Such materials may include, but are not limited to, plastics, polymers, and metal-polymer composites. Attachment device 400 includes a first attachment portion 410, a port attachment portion 420, and a second attachment portion 430. As will be described in more detail below, first attachment portion 410 may be configured to be snapped on, frictionally coupled to, or otherwise removably attached to first medical device 100. First attachment portion 410 may be attached to proximal end 100a of first medical device 100. In a preferred embodiment, first attachment portion 410 may be attached adjacent to distal end 110b of handle 110 so that port attachment portion 420 may be aligned with and/or attached to port 116. After attachment device 400 has been attached to proximal end 100a of first medical device 100, proximal end 200a of second medical device 200 may be removably attached to second attachment portion 430 to secure second medical device 200 to first medical device 100.

First attachment portion 410 includes a first jaw 412 and a second jaw 414. “Jaws” as used herein may be any holding portion or portions having opposed mating surfaces between which an instrument or device is held. In the exemplary embodiment, jaws 412, 414 have an arcuate shape having free ends that flare radially outward creating a space to receive handle 110. Jaws 412, 414 may, however, have any other shape, size, and/or configuration. Jaws 412, 414 may be made from a resilient material that may deflect to receive handle 110 and return to its original configuration to securely retain handle 110. With this arrangement, first attachment portion 410 may accommodate a range sizes of handle 110.

Port attachment portion 420 extends from first attachment portion 410 and has a longitudinal axis that is angled relative to a longitudinal axis of first attachment portion 410. Port attachment portion 420 may be aligned with port 116. In some embodiments port attachment portion 420 may be snapped on, frictionally coupled to, or otherwise removably attached to port 116 when first attachment portion 410 is attached to handle 110.

Port attachment portion 420 includes a port receiving portion 422 and a port seating portion 424. Port receiving portion 422 has an arcuate shape having free ends creating a space to receive port 116. The size and shape of port receiving portion 422 may be substantially similar to the size and shape of port 116 so as to align port receiving port 422 with port 116 and, in some embodiments, securely fit port receiving port 422 onto port 116. In embodiments where port receiving portion 422 engages port 116, portions of an inner surface of port receiving portion 422 may include surface roughening, adhesive materials, and/or one or more protrusions to facilitate engagement of port receiving portion 422 and port 116.

Port seating portion 424 is integrally formed with port receiving portion 422 and extends in a direction generally perpendicular to a longitudinal axis of port receiving portion 422. Port seating portion 424 may be configured to be aligned with, and in some embodiments, securely fit to proximalmost end 116a of port 116. Port seating portion 424 may include a slot 424a configured to facilitate insertion of proximalmost end 116a of port 116 into port seating port 424, and position port seating portion 424 about proximalmost end 116a of port 116. Port seating portion 424 may further include a notch 424b. Notch 424b may be configured to receive a portion of cap 117 (FIG. 3C) when port receiving portion 422 is aligned with port 116 and port seating portion 424 is aligned with proximalmost end 116a of port 116.

In alternative embodiments, port attachment portion 420 may additionally include a wire lock 426 extending from a proximal surface of port seating portion 424 (FIG. 3C). Wire lock 426 may be configured to receive a wire and/or cable associated with second medical device 200, to securely hold the wire and/or cable.

In other alternative embodiments, port attachment portion 420 may include a cap receiving portion 428 instead of a port seating portion 424 (FIG. 3D). As illustrated in FIG. 3D, cap receiving portion 428 may have a first side wall 428a, a second side wall 428b, a third wall 428c extending between first side wall 428 and second side wall 428b. Third wall 428c may be perpendicular to a longitudinal axis of port receiving portion 422 and spaced from proximal end 422a of port receiving portion 422. First wall 428a, second wall 428b, and third wall 428c, together, form a space therein. The space may be a continuation of the space created between the free ends of port receiving portion 422. Cap receiving portion 428 may further include a first opening 428e and a second opening 428f. As port receiving portion 422 is placed onto port 116, cap 117 may be inserted into first opening 428e to position cap 117 in the spaced created by first side wall 428a, second side wall 428b, and third wall 428c. When cap 117 is fully received in cap receiving portion 428, a portion of cap 117 may be received in notch 424b. As shown in FIG. 3D, third wall 428c includes a slit 428d. Slit 428d may be sized to receive a wire and/or cable associated with second medical device 200, to securely hold the wire and/or cable when cap 117 is removed from proximalmost end 116a of port 116.

Referring back to FIG. 3A, second attachment portion 430 is positioned adjacent to first attachment portion 410, and extends in a direction opposite jaws 412, 414. Second attachment portion 430 includes a mounting wall 434 and a pair of side walls that, together, define a cavity 436 therein.

As in the prior embodiment, second medical device 200 may be configured to be removably attached to second attachment portion 430 via securing device 218. In this embodiment, however, mounting wall 434 includes a protrusion 438, and mounting component 218b of securing device 218 may be a female engaging member having a complementary shaped recess configured to receive and retain protrusion 438. With this arrangement, mounting component 218b may be snapped onto, frictionally coupled to, or otherwise removably attached to protrusion 438 to secure proximal end 200a of second medical device 200 to attachment device 400. It is contemplated that securing device 218 may further include one or more additional spring flanges or clips to be received in cavity 436 when protrusion 438 is received in mounting component 218b. Such an arrangement may further secure proximal end 200a of second medical device 200 to attachment device 400. When attachment device 400 is attached to both proximal end 100a of first medical device 100 and proximal end 200a of second medical device 200, second medical device 200 may be secured to first medical device 100. Second medical device 200 may be easily detached from first medical device 100 by disengaging mounting component 218b from second attachment portion 430.

In an alternative embodiment of second attachment portion 430 illustrated in FIG. 3B, mounting wall 434 includes a first protrusion 438a and a second protrusion 438b. Mounting component 218b may be snapped onto, frictionally coupled to, or otherwise removably attached to either first protrusion 438a or second protrusion 438b. First protrusion 438a and second protrusion 438b may provide a physician with flexibility in positioning and orienting second medical device 200 relative to first medical device 100. It is contemplated that a greater or less number of protrusions may be provided, and that the protrusions may be located on mounting wall 434 or side walls 432. It is further contemplated that one or more cavities may be formed by mounting wall 434 and side walls 432. In the exemplary embodiment, a first cavity 436a and a second cavity 436b are formed by mounting wall 434 and side walls 432. Cavities 436a, 436b may be configured to receive spring flanges or clips on securing device 218 to further secure second medical device 200 to first medical device 100.

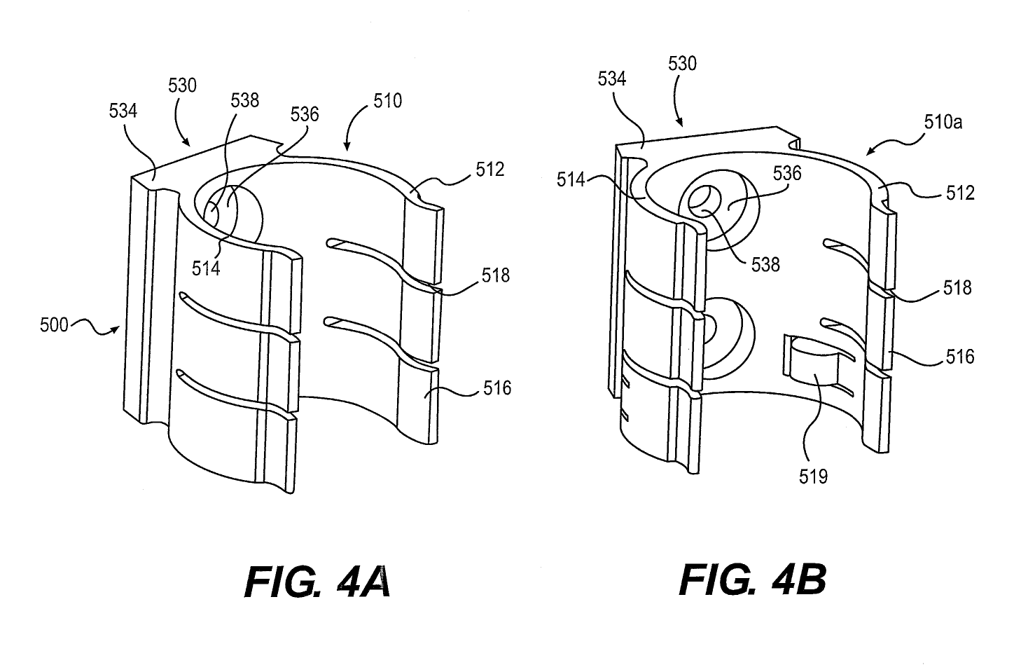

FIG. 4A illustrates an attachment device 500 in accordance with another embodiment of the disclosure. Attachment device 500 may be a one-piece structure fabricated from any known process such as, for example, injection molding, and constructed of flexible, semi-rigid, or rigid materials. Such materials may include, but are not limited to, plastics, polymers, and metal-polymer composites. Attachment device 500 includes a first attachment portion 510 and a second attachment portion 530. As in the previous embodiment, first attachment portion 510 may be configured to be snapped on, frictionally coupled to, or otherwise removably attached to proximal end 100a of first medical device 100. In an embodiment, first attachment portion 510 may be attached to handle 110 distal to port 116. Proximal end 200a of second medical device 200 may be configured to be removably attached to second attachment portion 530 after first attachment portion 510 has been attached to proximal end 100a of first medical device 100 to secure second medical device 200 to first medical device 100.

First attachment portion 510 includes a first jaw 512 and a second jaw 514. As in the embodiment illustrated in FIG. 3A, jaws 512, 514 have an arcuate shape having free ends that flare radially outward creating a space to receive handle 110. Jaws 512, 514 may be C-shaped or may have any other shape, size, and/or configuration to receive handle 110. As used herein, “C-shaped” means any shape that includes a discontinuous perimeter forming an open space or gap, and thus can have a non-rounded shape and/or additional features. Jaws 512, 514 may be made from a resilient material that may deflect to receive handle 110 and return to its original configuration to securely retain handle 110. With this arrangement, first attachment portion 510 may accommodate a range of sizes of handle 110.

As shown in the exemplary embodiment illustrated in FIG. 4A, jaws 512, 514 may additionally include cut out sections 518 laser cut into jaws 512, 514. The cut out sections 518 may have any size and/or shape, including slots shown in FIGS. 4A and 4B, and may create multiple flanges 516 that enhance the flexibility and/or grip of jaws 512, 514.

In alternative embodiments, jaws 512, 514 of first attachment portion 510b may additionally include one or more resilient protrusions 519 (FIG. 4B) on an inner surface of jaws 512, 514 to further facilitate attachment of first attachment portion 510 to handle 110. In the exemplary embodiment shown in FIG. 4B, protrusions 519 are cantilevers having elastic arms that attach to jaws 512, 514. Protrusions 519 may be configured to flex away from the space between jaws 512, 514 when handle 110 is inserted into the space between jaws 512, 514, so that protrusions 519 are biased securely against handle 110.

Second attachment portion 530 is positioned behind jaws 512, 514 (i.e., opposite the free ends of jaws 512, 514), and includes a mounting wall 534 having one or more recesses 536. As shown in FIG. 4B, recesses 536 are vertically aligned and centered on mounting wall 534 between jaws 512, 514. Recesses 536 may, however, be located on any other portion of mounting wall 534. Although two recesses 536 are depicted in FIG. 4B, it will be understood that mounting wall 534 may include a greater or lesser number of recesses 536. Each recess 536 defines an aperture 538 which extends through mounting wall 534.

As in the prior embodiments, second medical device 200 may be configured to be removably attached to second attachment portion 530 via securing device 218. In this embodiment, securing device 218 may include one or more mounting components 218b. The number of mounting components 218b may correspond to the number recesses 536. Mounting components 218b may be, for example, pegs having bulbous ends configured to be received and retained in apertures 538. In order to secure mounting components 218b in apertures 538, the one or more recesses 536 may be made of resilient material so as to open wide as each mounting component 218b is inserted into a corresponding aperture 538 and return to a position on the inserted mounting component 218b to attach second medical device 200 to attachment apparatus 500. When attachment apparatus 500 is attached to both proximal end 100a of first medical device 100 and proximal end 200a of second medical device 200, second medical device 200 may be secured to first medical device 100. Second medical device 200 may be easily detached from first medical device 100 by removing mounting component 218b from apertures 538 of second attachment portion 530.

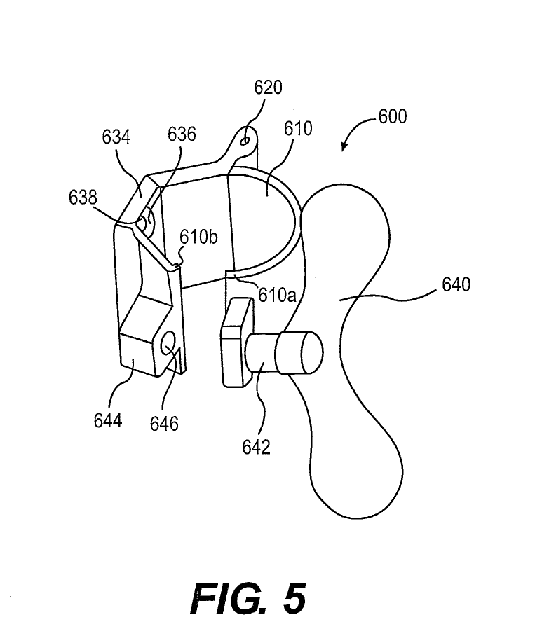

FIG. 5 illustrates an attachment device 600 in accordance with another embodiment of the disclosure. Attachment device 600 may be an assembly of multiple components including a clamping portion 610, a clamp adjusting portion (e.g., fitting 642 and fitting receiving portion 644), and a mounting portion 634.

Clamping portion 610 may be configured to be placed on and clamped to handle 110 of first medical device 100. In an embodiment, clamping portion 610 may be clamped on handle 110 at a position distal to port 116. Clamping portion 610 may have any size, shape, and/or configuration to be placed on handle 110. In the exemplary embodiment illustrated in FIG. 5, clamping portion 610 has a C-shaped configuration or substantially circular shape. In other embodiments, clamping portion 610 may have a U-shaped configuration and/or any other known configuration.

As illustrated in FIG. 5, clamping portion 610 includes a first end 610a, a second end 610b, and a hinge 620 disposed between first end 610a and second end 610b. Clamping portion 610 may pivot about hinge 620 to move first end 610a and second end 610b relative to each other. For example, first end 610a and second end 610b may be separated from each other to place clamping portion 610 on handle 110. First end 610a and second end 610b may then be brought together to clamp handle 110.

A fitting 642 is disposed on first end 610a and a fitting receiving member 644 is disposed on second end 610b. Fitting 642 and fitting receiving member 644 may, together, form a clamp adjusting portion. For example, fitting 642 may include a knob 640 and a plurality of threads (not shown) at an end of fitting 642 opposite to knob 640. Fitting 642 may be inserted into a bore 646 of fitting receiving member 644 when first end 610a and second end 610b are brought together. Knob 640 on fitting 642 may then be rotated to thread fitting 642 into bore 646 and adjust the clamping force of clamping portion 610 on handle 110. With this arrangement, attachment device 600 may be secured to handle 110 to prevent movement of attachment device 600 relative to first medical device 100. Other adjusting mechanisms for securing clamping portion 610 to handle 110 may also be contemplated.

Mounting portion 634 is positioned on clamping portion 610. In the exemplary embodiment, mounting portion 634 is a substantially flat wall of clamping portion 610. Mounting portion 634 includes one or more recesses 636. Each recess 636 defines an aperture 638 that extends through mounting portion 634.

Second medical device 200 may be configured to be removably attached to mounting portion 634 via securing device 218. In this embodiment, securing device 218 may include one or more mounting components 218b which may be, for example, pegs having bulbous ends configured to be received and retained in apertures 638. In order to secure mounting components 218b in apertures 638, the one or more recesses 636 may be made of resilient material so as to open wide as each mounting component 218b is inserted into a corresponding aperture 638 and returns to a position on the inserted mounting component. Upon insertion of mounting components 218b into apertures 638, proximal end 200a of second medical device 200 may be attached to attachment device 600. When attachment device 600 is attached to both proximal end 100a of first medical device 100 and proximal end 200a of second medical device 200, second medical device 200 is secured to first medical device 100. Second medical device 200 may be easily detached from first medical device 100 by removing mounting component 218b from apertures 638 of mounting portion 634.

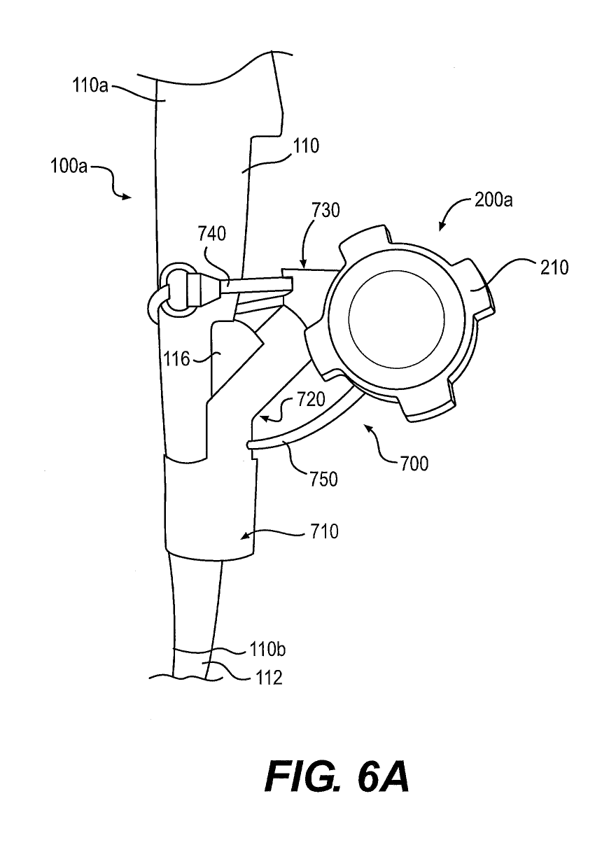

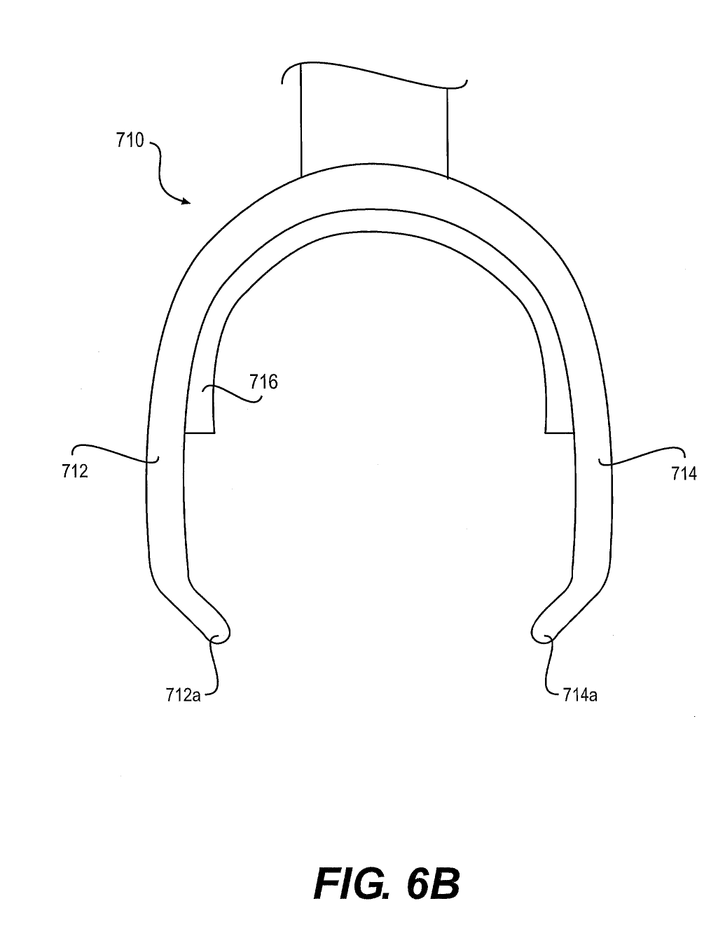

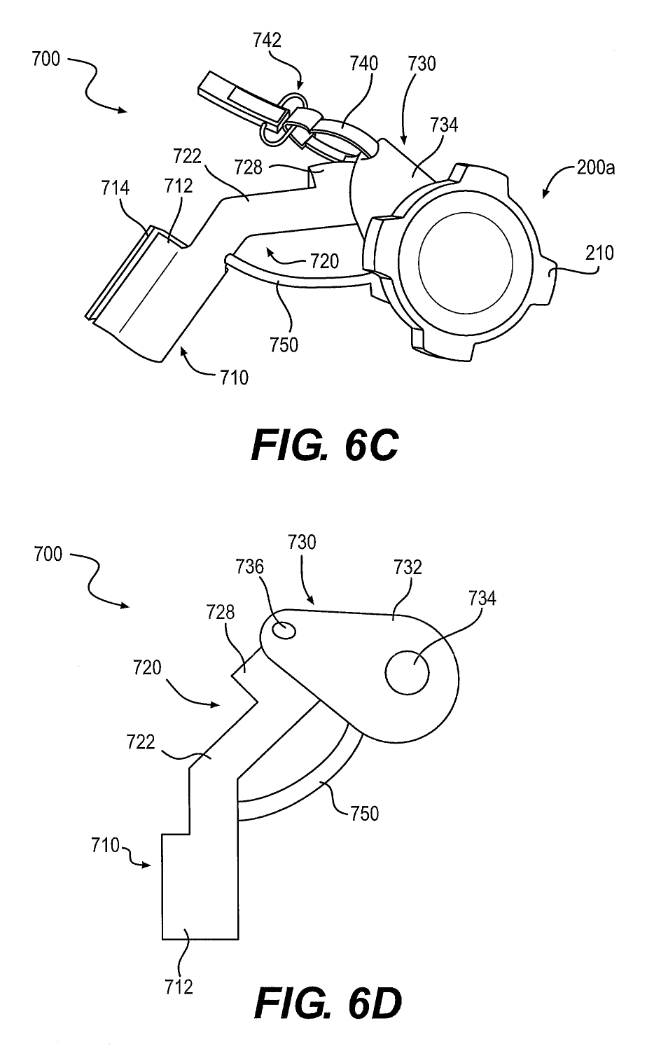

FIGS. 6A-6D illustrate an attachment device 700, in accordance with another embodiment of the disclosure. Attachment device 700 may be a one-piece structure fabricated from any known process such as, for example, injection molding, and constructed of a semi-rigid or rigid material. Such materials may include, but are not limited to, plastics, polymers, and metal-polymer composites. Attachment device 700 includes a first attachment portion 710, a port attachment portion 720, a second attachment portion 730, and a stabilization portion 750. Attachment device 700 further includes a flexible strap 740 attached to second attachment portion 730.

As will be described in more detail below, first attachment portion 710 and port attachment portion 720 may be configured to be snapped on, frictionally coupled to, or otherwise removably attached to proximal end 100a of first medical device 100. First attachment portion 710 may be attached to first medical device 700 adjacent distal end 110b of handle 110 and port attachment portion 720 may be aligned with and/or attached to port 116. Flexible strap 740 may extend from second attachment portion 730 and attach to handle 110 at a position proximal to first attachment portion 710, closer to and adjacent to proximal end 110a of handle 110 proximal of port 116. Proximal end 200a of second medical device 200 may be removably attached to or permanently attached to second attachment portion 730. With this arrangement, attachment device 700 may securely attach second medical device 200 to first medical device 100.

Referring to FIG. 6B, first attachment portion 710 includes a first jaw 712 and a second jaw 714. Jaws 712, 714 have an arcuate shape having free ends 712a, 714b, respectively, that create a space for receiving handle 110. It is contemplated that jaws 712, 714 may have any other shape, size, and/or configuration. Jaws 712, 714 may be made from a resilient material that deflect to receive handle 110 and return to its original configuration on handle 110 to securely retain handle 110. With this arrangement, first attachment portion 710 may accommodate a range of sizes of handle 110.

In some embodiments, free ends 712a, 714a of jaws 712, 714 may flare radially inward to facilitate attachment of jaws 712, 714 on handle 110. In some additional embodiments, jaws 712, 714 may include an elastomer 716 disposed on an inner surface of jaws 712, 714. Elastomer 716 may also be configured to facilitate attachment of first attachment portion 710 to handle 110. Jaws 712, 714 may alternatively include roughened surfaces, one or more protrusions, bumps, or other known features on an inner surface of jaws 712, 714 to facilitate attachment of first attachment portion 710 to handle 110. It should be noted that throughout the disclosure, any elastomer, foam, polymer, fabric or material that may promote retention between two devices, for example between attachment portion 710 and handle 110, may be used. Such a material can be easily customized to adapt to any of the embodiments disclosed herein.

Referring to FIG. 6C, port attachment portion 720 extends from first attachment portion 710 and has a longitudinal axis that is angled relative to a longitudinal axis of first attachment portion 710. Port attachment portion 720 may be aligned with port 116. In some embodiments port attachment portion 720 may be snapped on, frictionally coupled to, or otherwise removably attached to port 116 when first attachment portion 710 is attached to handle 110.

Port attachment portion 720 includes a port receiving portion 422 and a port seating portion 728. Port receiving portion 722 has an arcuate shape having free ends creating a space to receive port 116. The size and shape of port receiving portion 722 may be substantially similar to the size and shape of port 116 so as to align port receiving port 722 with port 116 and, in some embodiments, securely fit port receiving port 722 onto port 116. In those embodiments where port receiving portion 722 engages port 116, portions of an inner surface of port receiving portion 722 may include surface roughening, adhesive materials, and/or one or more protrusions to facilitate engagement of port receiving portion 722 and port 116.

Port seating portion 728 is integrally formed with a proximal end of port receiving portion 722 and extends in a direction perpendicular to the longitudinal axis of port receiving portion 722. Port seating portion 728 may be configured to be aligned with, and in some embodiments, securely fit to proximalmost end of port 116a. Port seating portion 728 may include one or more slots (see e.g., FIG. 3A) to facilitate insertion of proximalmost end 116a of port 116 into port seating port 728, and position port seating portion 728 about proximalmost end 116a of port 116. Port seating portion 728 may additionally and/or alternatively include a notch (see e.g., FIG. 3A) to receive a portion of cap 117 when port receiving portion 722 is aligned with port 116 and port seating portion 728 is aligned with proximalmost end 116a of port 116.

Referring to FIGS. 6C and 6D, second attachment portion 730 extends from port seating portion 728. In the exemplary embodiment, second attachment portion 730 may have a longitudinal axis that angled relative to port seating portion 728. Second attachment portion 730 includes a pair of mounting walls 732 (only one mounting wall is shown). Each mounting wall 732 is positioned on a respective side of port attachment portion 720.

Flexible strap 740 extends through a first bore 736 on mounting walls 732. In the exemplary embodiment, flexible strap 740 is secured to handle 110 by a hook and loop fastener 742 (VELCRO®). Alternatively, flexible strap 740 may be secured to handle 110 by other structures including, but not limited to, adhesives, mechanical fasteners, or ratcheting clips.

Proximal end 200a of second medical device 200 is attached to second attachment portion 730 via a second bore 734. In some embodiments, proximal end 200a of second medical device 200 may be removably attached to second attachment portion 730 by, for example, mechanical fasteners or clips configured to be received or retained in bore 734. Alternatively, proximal end 200a of second medical device 200 may be permanently attached to second attachment portion 730 by, for example, crimping, welding, or other known methods.

As shown in FIGS. 6A-6C, stabilization portion 750 may extend between first attachment portion 710 and second attachment portion 730, and may be a solid bar or rod. Stabilization portion 750 may be configured to provide structural support to attachment device 700. Stabilization portion 750 may additionally be configured to dampen energy as steering mechanism 214 of second medical device 200 is manipulated.

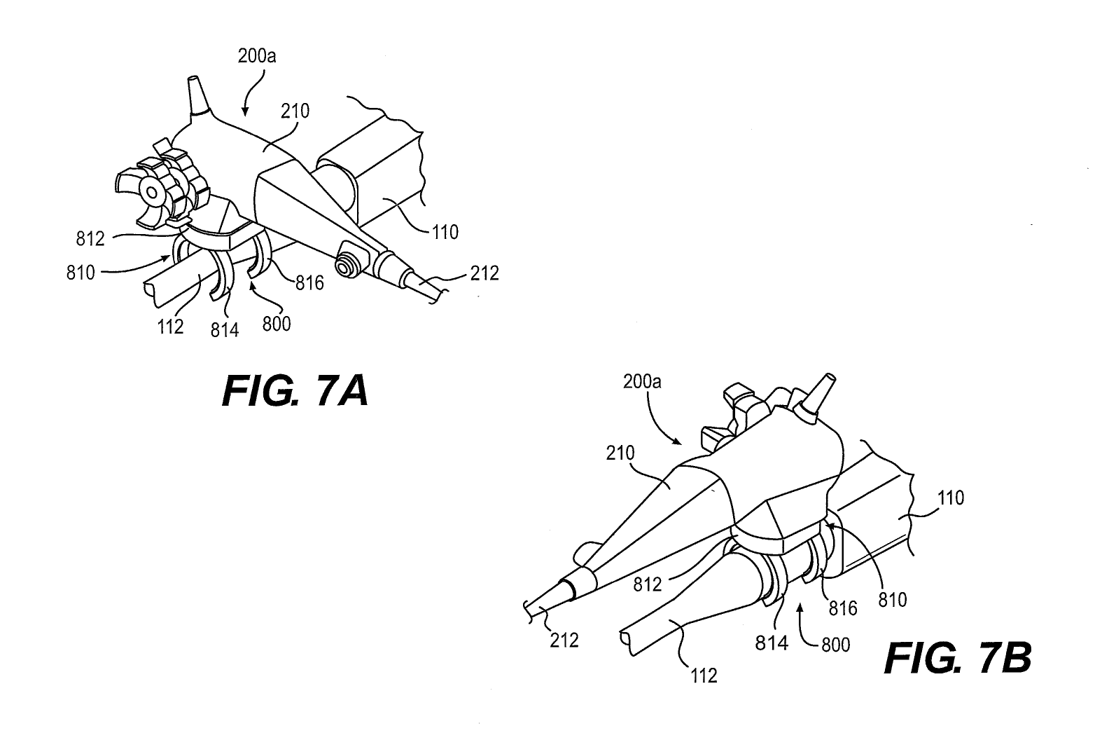

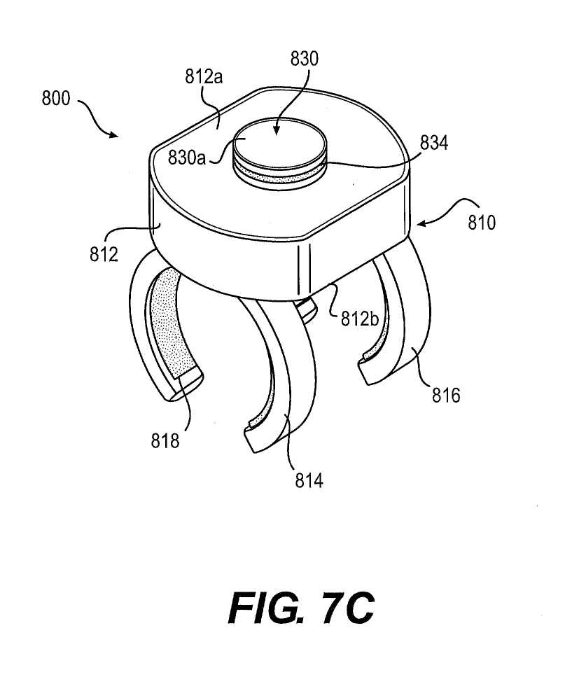

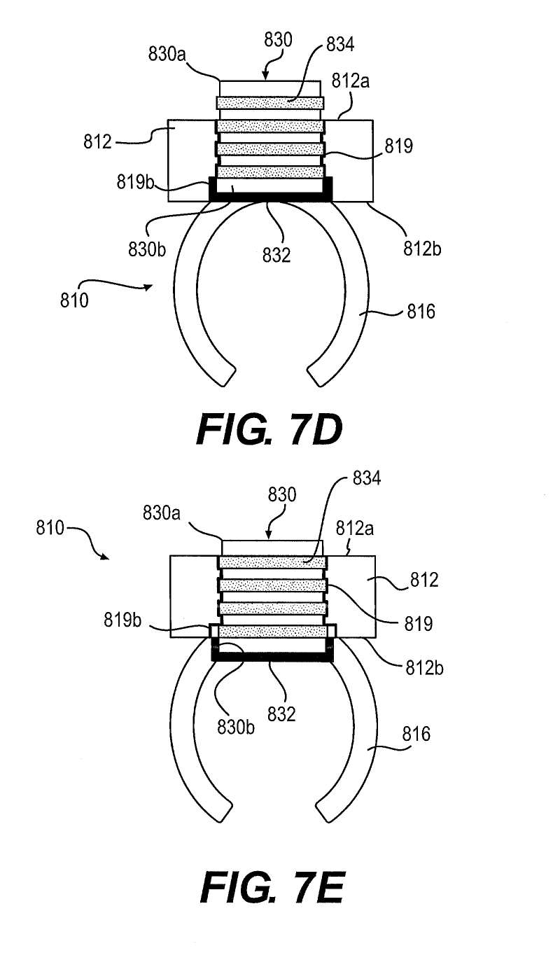

FIGS. 7A-7E illustrate an attachment device 800 in accordance with another embodiment of the disclosure. Attachment device 800 may be an assembly of multiple components including a clamping portion 810, a clamp adjusting portion 830, and a mounting portion (e.g., proximal end 830a of clamp adjusting portion 830).

Clamping portion 810 may be a one-piece structure constructed from semi-rigid or rigid materials. Such materials may include, for example, plastics or metals. Clamping portion 810 includes a base 812 and one or more clamps. Base 812 may include a first surface 812a, a second surface 812b opposite first surface 812a, and a bore 819 extending through first surface 812a and second surface 812b. First surface 812b may be configured to be placed adjacent handle 210 of second medical device 200.

Clamps 814, 816 may extend from second surface 812b away from first surface 812a. In the exemplary embodiment, clamping portion 810 includes two clamps 814, 816. A greater or lesser number of clamps are contemplated. Clamps 814, 816 may have any size, shape and/or configuration to slide over outer tube 112 and securely fit onto a portion of outer tube 112. In some embodiments, clamps 814 and 816 may be independent so as to clamp onto a tapered body (e.g., handle 110). In the exemplary embodiment, clamps 814, 816 are C-shaped clamps. Alternatively, clamps 814, 816 may be U-shaped clamps. As shown in FIG. 7C, an elastomer 818 is disposed on an inner surface of clamps 814, 816. Elastomer 818 may be configured to enhance the gripping strength between clamps 814, 816 and outer tube 112. Alternatively, clamps 814, 816 may include surface roughening, adhesive materials, one or more protrusions, or any other feature to enhance the gripping strength between clamps 814, 816 and outer tube 112.

Referring to FIGS. 7C and 7D, clamp adjusting portion 830 may be received in bore 819. Clamp adjusting portion 830 includes a first end 830a, a second end 830b, and a plurality of threads 834 disposed on clamp adjusting portion 830 between first end 830a and second end 830b. The mounting portion may be positioned at first end 830a. In the exemplary embodiment, the mounting portion is first end 830a of clamp adjusting portion 830. In this embodiment, first end 830a may be fixedly attached to handle 210 of second medical device 200 by, for example, crimping, welding, or other known methods. A clamping plate 832 may be fixed to, or alternatively, configured to rotate freely on second end 830b.

As illustrated in FIGS. 7A-7B, second medical device 200 may be configured to rotate relative to base 812 of clamping portion 810 and outer tube 112 after clamping portion 810 has been positioned on outer tube 112. In particular, handle 210 may be rotated between a first position substantially perpendicular to outer tube 112 and a second position substantially aligned with outer tube 112. Clamping plate 832 may be configured to be positioned in recess 819b when handle 210 of second medical device 200 is perpendicular to outer tube 112. Apparatus device 800 may be configured such that, when second medical device is rotated 90 degrees relative to outer tube 112 from the first position to the second position, clamp adjusting portion 830 may be threaded into bore 819 to drive clamping plate 832 down from recess 819b onto a surface of outer tube 112. Clamping plate 832 may exert a clamping force on outer tube 112 to lock proximal end 200a of second medical device 200 relative to first medical device 100 so as to prevent movement of proximal end 200a of second medical device 200 relative to first medical device 100. It will be understood that the pitch of threads 842 may be designed to optimize the clamping force of clamping plate 832. In alternative embodiments, clamp adjusting portion 830 may be, for example, a locking lever, a knob, a button, a ratchet, or any other known structure to secure clamping plate 832 onto outer tube 112, and lock the threaded clamping portion 830 into place. Any and all of the embodiments of this disclosure may allow second medical device 200 to rotate relative to first medical device 100. Further, in any rotatable embodiments, materials such a polymers, elastomers, foams, coatings, etc. may be located between rotating components, on an axle for example, to restrain free, uncontrolled rotation.

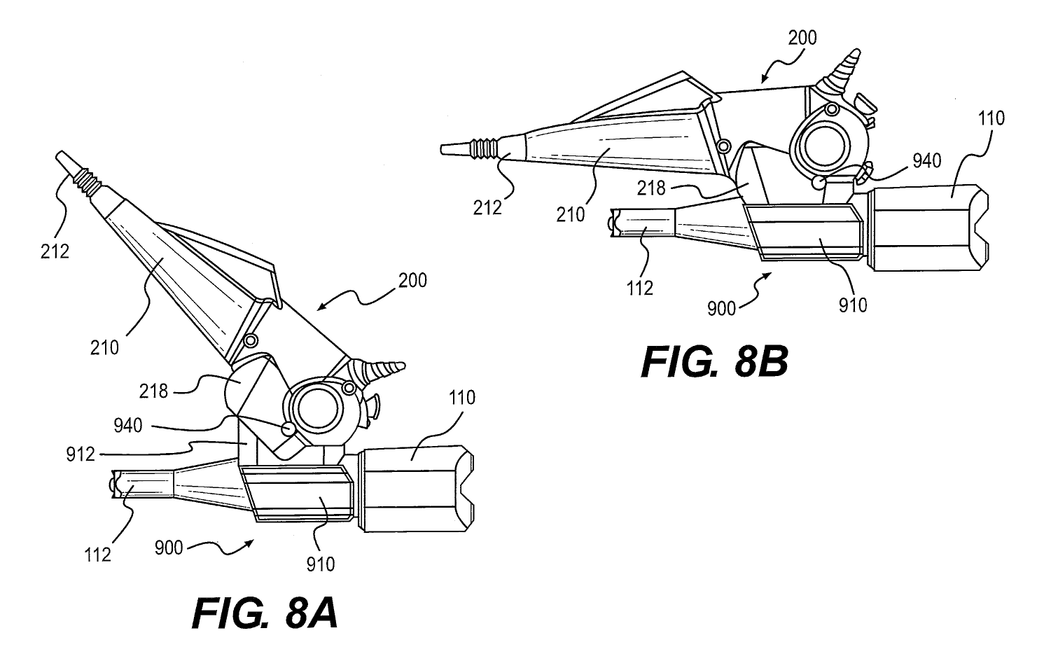

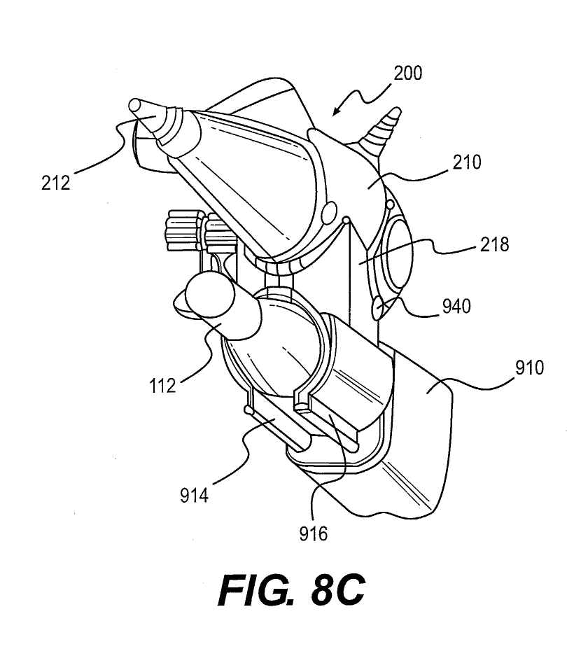

FIGS. 8A-8C illustrates an attachment device 900 in accordance with another embodiment of the disclosure. As shown in FIGS. 8A-8C, attachment device 900 includes a clamping portion 910 and a base 912. Clamping portion 910 includes two clamps 914, 916, however, a greater or lesser number of clamps are contemplated. Clamps 914, 916 may have any size, shape and/or configuration to slide over outer tube 112 and securely fit onto a portion of outer tube 112. In the exemplary embodiment, clamps 914, 916 are C-shaped clamps. Alternatively, clamps 914, 916 may be U-shaped clamps.

Base 912 is positioned behind clamps 914, 916 (i.e., opposite the free ends of clamps 914, 916). Second medical device 200 may be positioned adjacent to base 912 and coupled to base 912. In particular, second medical device 200 may include a mounting component 218 on handle 210, which may be may be coupled to base 912 by a mounting portion 940. Handle 210 of second medical device 200 may be configured to rotate about mounting portion 940 relative to outer tube 112 to move handle 210 between a first position (FIG. 8A) at an angle relative to outer tube 112 and a second position (FIG. 8B) aligned with outer tube 112.

Apparatus 900 may be configured such that, as handle 210 moves relative to outer tube 112 from the first position (FIG. 8A) to the second position (FIG. 8B), mounting component 218 may be configured to move relative to base 912 to contact an outer surface of clamping portion 910. As mounting component 218 contacts clamping portion 910, mounting component 218 may exert a force on clamping portion 910 to effect closure of clamps 914, 916 against outer tube 112 so as to prevent movement of proximal end 200a of second medical device 200 relative to first medical device 100. In alternative embodiments, a ratcheting mechanism may be contemplated. Ratcheting mechanisms may be used with any of the embodiments of the disclosure herein; for example, to control rotation between two devices or components.

The attachment devices described herein are designed to be easily and quickly attached to and detached from a first medical device and may permit a second medical device to be attached to and detached from the attachment devices. The attachment devices, once attached to both the first medical device and the second medical device, may allow the physician to grasp only a single medical device while the other medical device remains securely attached to the one being grasped. The attachment devices may provide certain additional benefits. For example, the attachment devices may reduce movement of the proximal end of the second medical device relative to the first medical device and orient the proximal end of the second medical device relative to the first medical device to securely seat the elongate member of the second medical device in the port of the first medical device. In some embodiments, the attachment device may additionally limit and/or prevent the loss of suction from port of the first medical device. Suction loss may be prevented by the tight fit of the port seating portion with the biopsy cap, preventing over or under tightening of other portions of the attachment device (e.g., Velcro strap in the embodiment of FIGS. 6A-6D).

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A device for securing a second medical device to a first medical device, the device comprising:
a first portion configured to securely fit onto the first medical device;
a port portion adjacent to the first portion, the port portion being configured to align with a port of the first medical device and orient the first medical device relative to the second medical device so that an elongate member of the second medical device can be inserted into the port; and
a second portion configured to be coupled to the second medical device so as to control movement of the second medical device relative to the first medical device.

2. The device of claim 1, wherein the first portion includes a pair of jaws configured to deflect to receive the first medical device and return to substantially an original configuration to securely retain the first medical device.

3. The device of claim 1, wherein the port portion is an opening defined by the first portion.

4. The device of claim 1, wherein the first portion has a first longitudinal axis, the port portion has a second longitudinal axis angled relative to the first longitudinal axis, and wherein the port portion is configured to securely fit onto the port.

5. The device of claim 1, wherein the port portion includes a port receiving portion and a port seating portion, wherein the port seating portion is configured to receive a proximalmost end of the port.

6. The device of claim 1, wherein the port portion has a first end and a second end, wherein the first portion extends from the first end in a first direction and the second portion extends from the second end in a second direction that is different than the first direction.

7. The device of claim 1, further including a flexible strap extending from the second portion and configured to secure the second portion to the first medical device.

8. A device for securing a second medical device to a first medical device, the device comprising:
a clamping portion configured to clamp onto the first medical device;
an adjusting member configured to move relative to the clamping portion, wherein the adjusting member is configured to restrict the clamping portion from moving relative to the first medical device; and
a mounting portion configured to be coupled to the second medical device so as to securely seat an elongate member of the second medical device in a port of the first medical device.

9. The device of claim 8, wherein the clamping portion has a C-shaped configuration and defines a first end and a second end.

10. The device of claim 9, wherein the adjusting portion includes a fitting and a fitting receiving member, wherein the fitting is disposed on the first end of the clamping portion, and the fitting receiving member is disposed on the second end of the clamping portion.

11. The device of claim 10, wherein the fitting includes a knob and a plurality of threads on an end of the fitting opposite the knob, and wherein, on rotation of the knob, the fitting is configured to be threaded into a bore of the fitting receiving member.

12. The device of claim 8, wherein the mounting portion includes at least one recess having an aperture configured to receive a securing device on the second medical device.

13. The device of claim 8, wherein the clamp portion includes:
a base having a first surface, a second surface, and a bore extending through the first surface and the second surface; and
wherein the clamping portion extends from the second surface.

14. The device of claim 13, wherein the adjusting member is threaded in the bore, wherein the mounting portion is disposed on a first end of the adjusting member and fixed to the second medical device, and wherein a clamping plate is disposed on a second end of the adjusting member.

15. The device of claim 14, wherein, when the second medical device is rotated from a first position, in which a longitudinal axis of the second medical device is at an angle to a longitudinal axis of the first medical device, to a second position, the clamping plate is moved from a first position within the bore to a second position contacting the first medical device.

16. The device of claim 15, wherein the longitudinal axis of the second medical device is substantially aligned with the longitudinal axis of the first medical device when the clamping plate is in the second position.

17. The device of claim 15, wherein the clamping plate applies a clamping force to an outer surface of the first medical device in the second position to lock the second medical device to the first medical device.

18. A device for securing a second medical device to a first medical device, the device comprising:
a first portion configured to securely fit onto a handle of the first medical device, the first portion having a pair of jaws configured to deflect to receive the handle and return to substantially an original configuration to securely retain the handle; and
a second portion configured to be coupled to the second medical device so as to hinder movement of the second medical device relative to the first medical device,
wherein the second portion is configured to receive and retain a mounting component coupled to the second medical device.

19. The device of claim 18, further including at least one protrusion disposed on an inner surface of the jaws, the protrusion being configured to deflect when the first medical device is inserted between the pair of jaws.

20. The device of claim 18, wherein each jaw of the pair of jaws includes at least one slot to enhance flexibility.
